(19) United States
(12) Patent Application Publication
(10) Pub. No.: US 2025/0119835 A1
(43) Pub. Date: Apr. 10, 2025

(54) WIRELESS COMMUNICATION DEVICE AND POWER SAVING METHOD THEREOF

(71) Applicant: REALTEK SEMICONDUCTOR CORP., Hsinchu (TW)

(72) Inventor: Hou-Ji Dai, Hsinchu (TW)

(73) Assignee: REALTEK SEMICONDUCTOR CORP., Hsinchu (TW)

(21) Appl. No.: 18/900,123

(22) Filed: Sep. 27, 2024

(30) Foreign Application Priority Data
Oct. 4, 2023 (TW) 112138169

(51) Int. Cl. H04W 52/02; H04L 49/109

(52) U.S. Cl. CPC H04W 52/0235; H04L 49/109

(57) ABSTRACT

A wireless communication device and a power saving method are provided. The wireless communication device includes a wireless communication circuit, a system chip, a wake-up controller, and a beacon communication circuit. The system chip is electrically connected to the wireless communication circuit. The system chip is configured to successively make the wireless communication circuit and the system chip sleep in response to a power saving demand and configured to receive a wake-up signal to successively awake the system chip and the wireless communication circuit. The wake-up controller is electrically connected to the system chip. The wake-up controller is configured to send the wake-up signal to the system chip. The beacon communication circuit is electrically connected to the wake-up controller. The beacon communication circuit is configured to send a beacon packet periodically according to a transmission period.

### CROSS-REFERENCE TO RELATED APPLICATION

This non-provisional application claims priority under 35 U.S.C. § 119 (a) to Patent Application 112138169 filed in Taiwan, R.O.C. on Oct. 4, 2023, the entire contents of which are hereby incorporated by reference.

### BACKGROUND

### Technical Field

The present disclosure relates to wireless communication techniques, and particularly relates to a wireless communication device and a power saving method thereof.

### Related Art

A wireless communication device known to the inventor adopts a radio frequency integrated circuit (RFIC) with a larger process dimension (for example, 55 nanometers) to transmit radio frequency (RF) signals. The RFIC with the larger process dimension causes a higher power loss in the wireless communication device known to the inventor and leads to a problem of reduced power durability for the wireless communication device known to the inventor. Although the problem of power consumption can be effectively improved by reducing the transmission power of RF signals, reducing the transmission power of RF signals may also lead to a problem of weak wireless network signals for the wireless communication device known to the inventor.

### SUMMARY

In order to address the problem(s) mentioned above, the present disclosure provides a wireless communication device and a power saving method thereof. In one or some embodiments, the wireless communication device comprises a system chip, a wake-up controller, and a beacon communication circuit. The system chip is electrically connected to the wireless communication circuit. The system chip is configured to successively make the wireless communication circuit and the system chip sleep in response to a power saving demand and configured to receive a wake-up signal to successively awake the system chip and the wireless communication circuit. The wake-up controller is electrically connected to the system chip. The wake-up controller is configured to send the wake-up signal to the system chip. The beacon communication circuit is electrically connected to the wake-up controller. The beacon communication circuit is configured to send a beacon packet periodically according to a transmission period, and the beacon communication circuit is configured to alternately enter into a working state and a sleeping state multiple times in every transmission period. The beacon communication circuit listens to at least one connection request signal when the beacon communication circuit enters into the working state.

In some embodiments, the system chip is further configured to disable an interrupt function of the system chip.

In some embodiments, the at least one connection request signal includes an authentication request packet sent from a station or a data packet sent from the station, and the wake-up controller sends the wake-up signal to the system chip when the beacon communication circuit listens to the authentication request packet or the data packet.

In some embodiments, the at least one connection request signal further includes a probe request packet sent from the station, and the beacon communication circuit sends a probe response packet to the station when the beacon communication circuit listens to the probe request packet.

In some embodiments, a duty cycle of the transmission period is between 30% and 80%.

In some embodiments, the beacon communication circuit alternately enters into the working state and the sleeping state 5 times in every transmission period.

In one or some embodiments, the power saving method comprises: making the wireless communication circuit sleep in response to a power saving demand; disabling an interrupt function of the system chip and making the system chip sleep; and sending a beacon packet periodically according to a transmission period and alternately entering into a working state and a sleeping state multiple times in every transmission period when the system chip and the wireless communication circuit sleep.

In some embodiments, the power saving method further comprises: receiving an authentication request packet sent from a station or a data packet sent from the station; triggering the wake-up controller to send a wake-up signal to the system chip to wake up the system chip; waking up the wireless communication circuit; and controlling the wireless communication circuit to communicate with the station.

In some embodiments, the power saving method further comprises: receiving a probe request packet sent from a station; sending a probe response packet to the station; receiving an authentication request packet sent from a station or a data packet sent from the station; triggering the wake-up controller to send a wake-up signal to the system chip to wake up the system chip; waking up the wireless communication circuit; and controlling the wireless communication circuit to communicate with the station.

In conclusion, according to one or some embodiments, the wireless communication device controls the wireless communication circuit and the system chip to sleep so as to reduce the power consumption during standby. Moreover, the wireless communication device further reduces the power consumption during standby by adjusting the duty cycle of the transmission period for the beacon communication circuit. Besides, since the beacon communication circuit alternately enters into the working state and the sleeping state multiple times in every transmission period, the communication performance of the wireless communication device can be maintained while reducing the power consumption of the wireless communication device.

### BRIEF DESCRIPTION OF DRAWINGS

The instant disclosure will become more fully understood from the detailed description given herein below for illustration only, and therefore not limitative of the instant disclosure, wherein:

FIG. 1 illustrates a module block diagram of a wireless communication device according to some embodiments of the present disclosure;

FIG. 2 illustrates a schematic diagram of a first embodiment of the wireless communication device shown in FIG. 1 and a station;

FIG. 3 illustrates a flow chart showing operations of a wireless communication device according to some embodiments of the present disclosure;

FIG. 4 illustrates a schematic graph of a first embodiment of a transmission period of a beacon packet sent from a beacon communication circuit shown in FIG. 1;

FIG. 5 illustrates a schematic graph of a second embodiment of a transmission period of a beacon packet sent from a beacon communication circuit shown in FIG. 1;

FIG. 6 illustrates a schematic graph of a third embodiment of a transmission period of a beacon packet sent from a beacon communication circuit shown in FIG. 1;

FIG. 7 illustrates a schematic diagram of a second embodiment of the wireless communication device shown in FIG. 1 and a station;

FIG. 8 illustrates a flow chart showing operations of a first embodiment following after the step S120 shown in FIG. 3;

FIG. 9 illustrates a schematic diagram of a third embodiment of the wireless communication device shown in FIG. 1 and a station;

FIG. 10 illustrates a flow chart showing operations of a second embodiment following after the step S120 shown in FIG. 3;

FIG. 11 illustrates a schematic current graph of one embodiment of the wireless communication device shown in FIG. 4; and

FIG. 12 illustrates a schematic current graph of one embodiment of the wireless communication device shown in FIG. 6.

### DETAILED DESCRIPTION

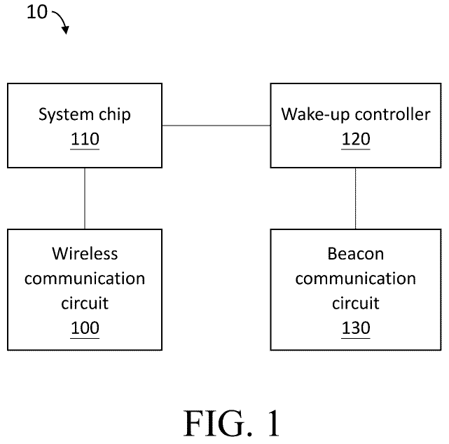

Please refer to FIG. 1. A wireless communication device 10 includes a wireless communication circuit 100, a system chip 110, a wake-up controller 120, and a beacon communication circuit 130. In some embodiments, the system chip 110 is electrically connected to the wireless communication circuit 100, the wake-up controller 120 is electrically connected to the system chip 110, and the beacon communication circuit 130 is electrically connected to the wake-up controller 120. In some embodiments, the wireless communication device 10 is, for example, a mobile wireless sharer (Mi-Fi), a base station, a wireless router, or a wireless access point (AP), but is not limited thereto.

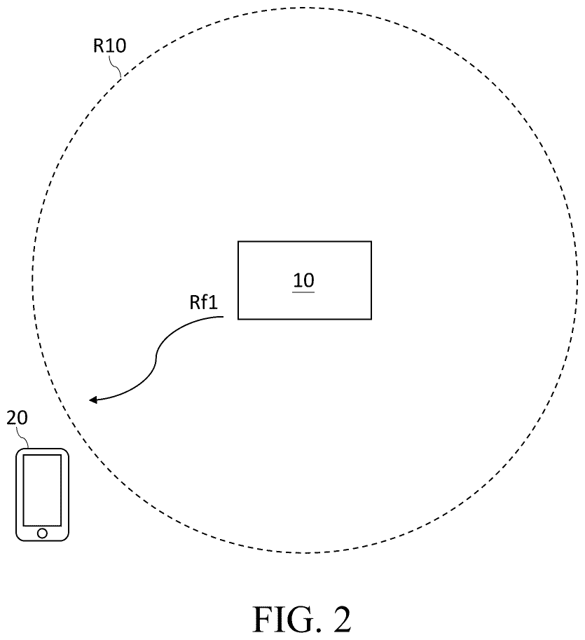

Please refer to FIG. 2. Since a station (STA) 20 does not enter into a signal range R10 of the wireless communication device 10, the station 20 is not yet able to communicate with the wireless communication device 10. In some embodiments, the signal range R10 may be the maximum range that radio frequency (RF) signals (for example, beacon packet Rf1) sent from the wireless communication device 10 can reach. In other words, in some embodiments, the station 20 may listen to the RF signals sent from the wireless communication device 10 within the signal range R10. In some embodiments, the station 20 may be a device which has a wireless communication function, such as but not limited to a smartphone, a tablet computer, a laptop computer, a desktop computer, a handheld gaming console, a home gaming console, an intelligent camera, or a wireless monitor.

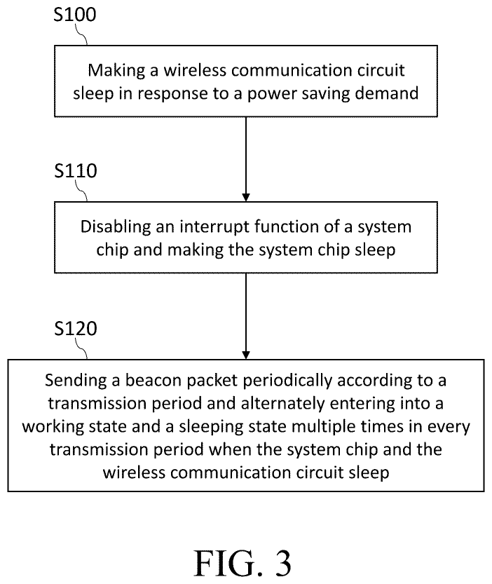

Please refer to FIG. 1 to FIG. 3. FIG. 3 illustrates a flow chart showing operations of a wireless communication device 10 according to some embodiments of the present disclosure. The system chip 110 of the wireless communication device 10 makes the wireless communication circuit 100 sleep in response to a power saving demand (the step S100). In some embodiment, the wireless communication device 10 communicates with the station 20 through the wireless communication circuit 100. When the wireless communication circuit 100 is powered on and does not communicate with the station 20, the wireless communication device 10 generates the power saving demand. Therefore, the system chip 110 makes the wireless communication circuit 100 sleep to reduce the power consumption of the wireless communication device 10.

In some embodiments, the wireless communication circuit 100 may be an RF integrated circuit (RFIC) which has a wireless communication function, such as but not limited to a Wi-Fi chip. In some embodiments, the system chip 110 may be a logic circuit or a control circuit, such as but not limited to a central processing unit (CPU), a system-on-chip (SoC), a microprocessor unit (MCU), a field programmable gate array (FPGA), or a complex programmable logic device (CPLD).

After the step S100, when the wireless communication circuit 100 sleeps, the system chip 110 disables an interrupt function of the system chip 110 and makes the wireless communication circuit 100 itself sleep (the step S110). When the system chip 110 receives signals sent from other circuits in the wireless communication device 10, the interrupt function of the system chip 110 is triggered to make the system chip 110 maintain in an operating state. Therefore, in some embodiments, the system chip 110 disables the interrupt function before sleeping to prevent the system chip 110 from being triggered by the interrupt function and being unable to sleep.

In some embodiments, when the wireless communication circuit 100 sleeps, the wireless communication circuit 100 is powered off to reduce the power consumption of the wireless communication device 10, and the wireless communication circuit 100 ends up sleeping when the wireless communication circuit 100 is awakened. Likewise, in some embodiments, the system chip 110 is powered off to reduce the power consumption of the wireless communication device 10, and the system chip 110 ends up sleeping when the system chip 110 is awakened.

Please refer to FIG. 1 to FIG. 6. After the step S100, when both of the wireless communication circuit 100 and the system chip 110 sleep, the beacon communication circuit 130 sends a beacon packet Rf1 periodically according to a transmission period Ttb and alternately enters into a working state and a sleeping state multiple times in every transmission period Ttb (the step S120). In some embodiments, the beacon communication circuit 130 maintains a first period T1 when the beacon communication circuit 130 enters into the working state, and the beacon communication circuit 130 maintains a second period T2 when the beacon communication circuit 130 enters into the sleeping state.

In other words, in some embodiments, the beacon communication circuit 130 sends the beacon packet Rf1 once every transmission period Ttb (for example, every 100 milliseconds (ms), but is not limited thereto). After the beacon communication circuit 130 finishes sending the beacon packet Rf1, the beacon communication circuit 130 enters into the working state and maintains the first period T1. After the first period T1, the beacon communication circuit 130 enters into the sleeping state and maintains the second period T2. After the second period T2, the beacon communication circuit 130 enters into the sleeping state again and maintains the second period T2. The beacon communication circuit 130 alternately enters into the working state and the sleeping state until the transmission period Ttb is ended.

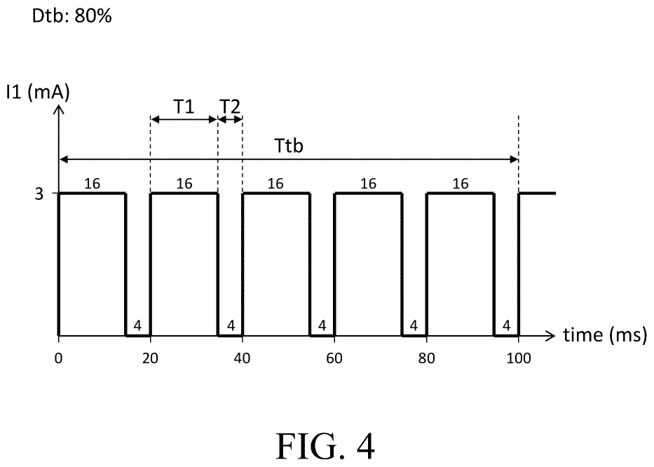

Take FIG. 4 for example. In the embodiment shown in FIG. 4, the length of the transmission period Ttb is 100 ms, the length of the first period T1 is 16 ms, and the length of the second period T2 is 4 ms. In other words, in this embodiment, the beacon communication circuit 130 enters into the working state and the sleeping state 5 times in every transmission period Ttb.

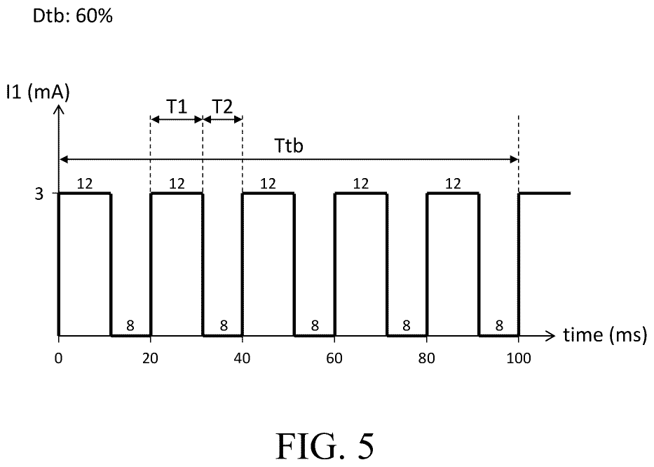

Further take FIG. 5 for example. In the embodiment shown in FIG. 5, the length of the transmission period Ttb is 100 ms, the length of the first period T1 is 12 ms, and the length of the second period T2 is 8 ms. In other words, in this embodiment, the beacon communication circuit 130 enters into the working state and the sleeping state 5 times in every transmission period Ttb.

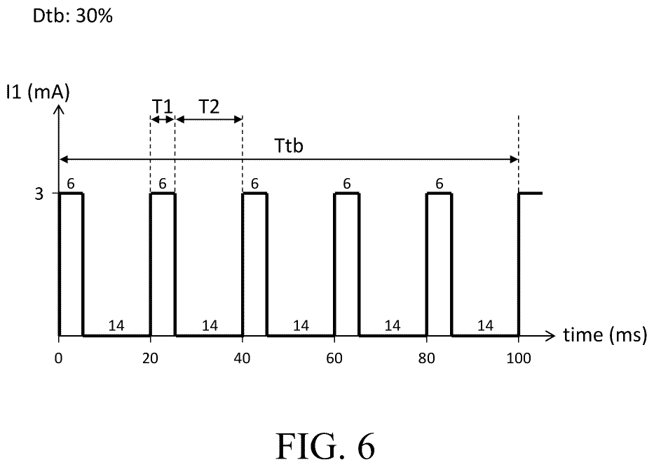

Further take FIG. 6 for example. In the embodiment shown in FIG. 6, the length of the transmission period Ttb is 100 ms, the length of the first period T1 is 6 ms, and the length of the second period T2 is 14 ms. In other words, in this embodiment, the beacon communication circuit 130 enters into the working state and the sleeping state 5 times in every transmission period Ttb.

In some embodiments, when the beacon communication circuit 130 enters into the working state, it indicates that the beacon communication circuit 130 can listen to the RF signals sent by the station 20 and the power of the beacon communication circuit 130 (i.e., in some embodiments, a current I1 of the beacon communication circuit 130) is at a high level (such as but not limited to 3 milliamps (mA)). In some embodiments, the longer the time that the beacon communication circuit 130 enters into the working state (i.e., the first period T1), the easier the beacon communication circuit 130 listens to the RF signals sent from the station 20 within the transmission period Ttb. In other words, in some embodiments, when the beacon communication circuit 130 enters into the working state, the signal of the wireless communication device 10 is stronger, and the wireless communication device 10 consumes more power.

In some embodiments, when the beacon communication circuit 130 enters into the sleeping state, it indicates that the beacon communication circuit 130 cannot listen to the RF signals sent by the station 20 and the power of the beacon communication circuit 130 (i.e., in some embodiments, a current I1 of the beacon communication circuit 130) is at a low level (such as but not limited to 0 mA). In some embodiments, the longer the time that the beacon communication circuit 130 enters into the sleeping state (i.e., the second period T2), the harder the beacon communication circuit 130 listens to the RF signals sent from the station 20 within the transmission period Ttb. In other words, in some embodiments, when the beacon communication circuit 130 enters into the sleeping state, the signal of the wireless communication device 10 is weaker, and the wireless communication device 10 consumes less power.

In some embodiments, a duty cycle Dtb of the transmission period Ttb is between 30% and 80%, and the duty cycle Dtb is related to the length of the first period T1 and the length of the second period T2 (i.e., in some embodiments, Dtb=T1/(T1+T2)). The larger the duty cycle Dtb of the transmission period Ttb, the longer the time that the beacon communication circuit 130 enters into the working state. When the duty circle Dtb of the transmission period Ttb is larger, the wireless communication device 10 can communicate with the station 20 easier because the signal of the wireless communication device 10 is stronger, and the wireless communication device 10 consumes more power. On the other hand, the smaller the duty cycle Dtb of the transmission period Ttb, the longer the time that the beacon communication circuit 130 enters into the sleeping state. When the duty circle Dtb of the transmission period Ttb is smaller, the wireless communication device 10 can communicate with the station 20 harder because the signal of the wireless communication device 10 is weaker, and the wireless communication device 10 consumes less power. Therefore, according to one or some embodiments, users can adjust the duty cycle Dtb of the transmission period Ttb according to different needs to achieve the optimized effect of the wireless communication device 10.

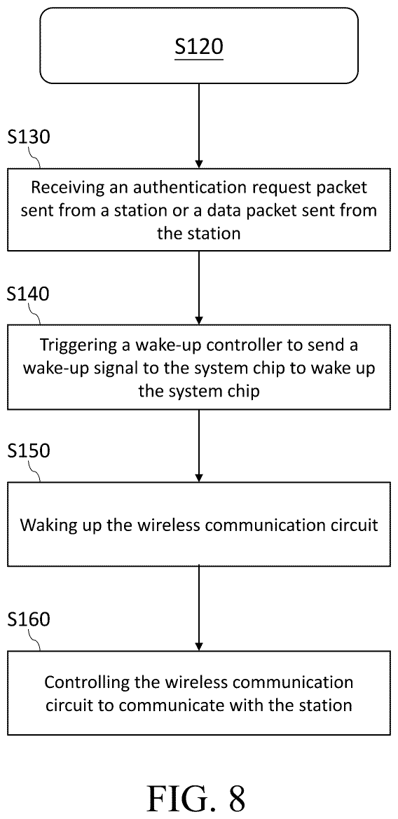

Please refer to FIG. 1 and FIG. 3 to FIG. 8. After the step S120, when the station 20 enters into the signal range R10 of the wireless communication device 10, the station 20 is able to receive the beacon packet Rf1 sent from the wireless communication device 10. When the station 20 listens to the beacon packet Rf1, the station 20 sends an authentication request packet Rf2 or a data packet (not shown) to the wireless communication device 10 to inform the wireless communication device 10 to communicate with the station 20. At this moment, the beacon communication circuit 130 receives the authentication request packet Rf2 sent from the station 20 or the data packet sent from the station 20 (the step S130). When the beacon communication circuit 130 listens to authentication request packet Rf2 sent from the station 20, the beacon communication circuit 130 triggers the wake-up controller 120 to send a wake-up signal to the system chip 110 to wake up the system chip 110 (the step S140). Afterwards, the system chip 110 wakes up the wireless communication circuit 100 after the system chip 110 is awakened (the step S150). Finally, the system chip 110 controls the wireless communication circuit 100 to communicate with the station 20 (the step S160) so as to make the wireless communication circuit 100 and the station 20 able to communicate with each other.

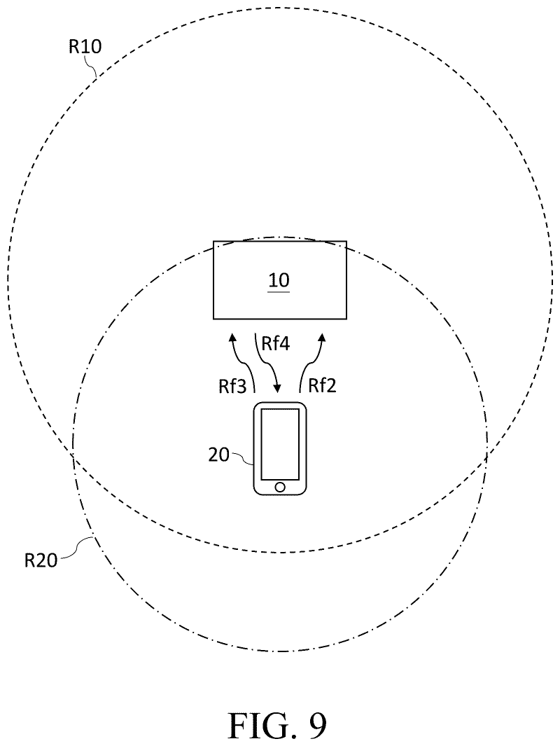

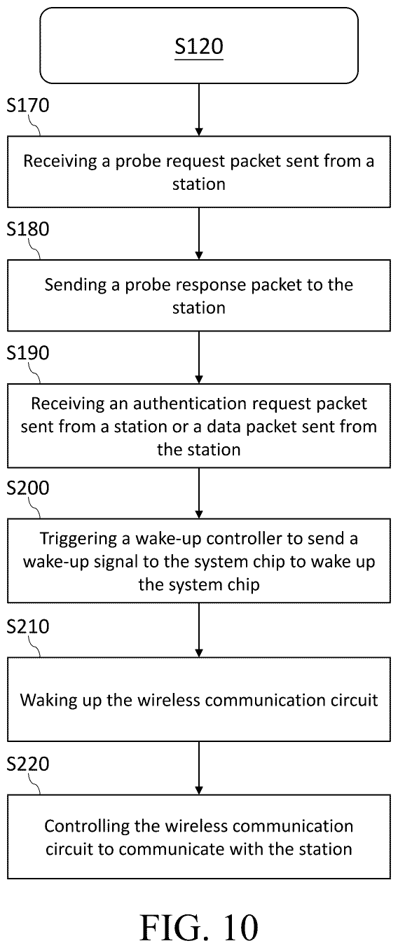

Please refer to FIG. 1, FIG. 3 to FIG. 6, and FIG. 9 to FIG. 10. After the step S120, when the station 20 enters into the signal range R10 of the wireless communication device 10, the station 20 may not receive the beacon packet Rf1 sent from the wireless communication device 10. When the station 20 does not receive any beacon packet Rf1 sent from the wireless communication device 10, the station 20 can send a probe request packet Rf3 to search whether a wireless communication device 10 which can be connected exists within the signal range R20 of the station 20. When the beacon communication circuit 130 listens to the probe request packet Rf3 sent from the station 20 (the step S170), the beacon communication circuit 130 sends a probe response packet Rf4 to the station 20 (the step S180) to inform the station 20 that the wireless communication device 10 exists within the signal range R20 of the station 20. When the station 20 listens to the probe response packet Rf4, the station 20 sends an authentication request packet Rf2 or a data packet (not shown) to the wireless communication device 10 to inform the wireless communication device 10 to communicate with the station 20. At this moment, the beacon communication circuit 130 receives the authentication request packet Rf2 sent from the station 20 or the data packet sent from the station 20 (the step S190). When the beacon communication circuit 130 listens to the authentication request packet Rf2 sent from the station 20, the beacon communication circuit 130 triggers the wake-up controller 120 to send a wake-up signal to the system chip 110 to wake up the system chip 110 (the step S200). Afterwards, the system chip 110 wakes up the wireless communication circuit 100 after the system chip 110 is awakened (the step S210). Finally, the system chip 110 controls the wireless communication circuit 100 to communicate with the station 20 (the step S220) so as to make the wireless communication circuit 100 and the station 20 able to communicate with each other.

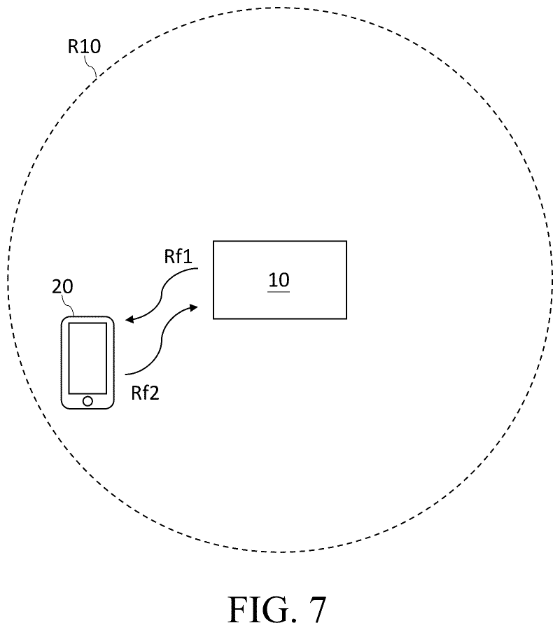

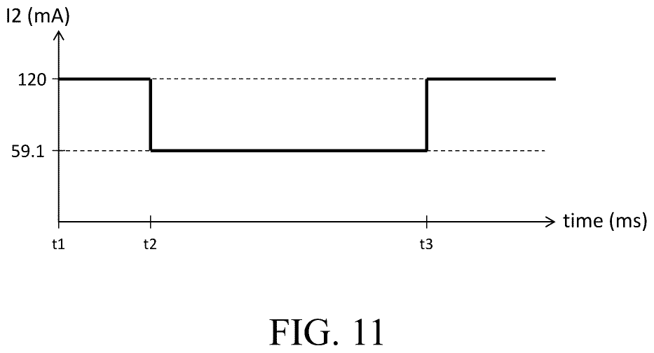

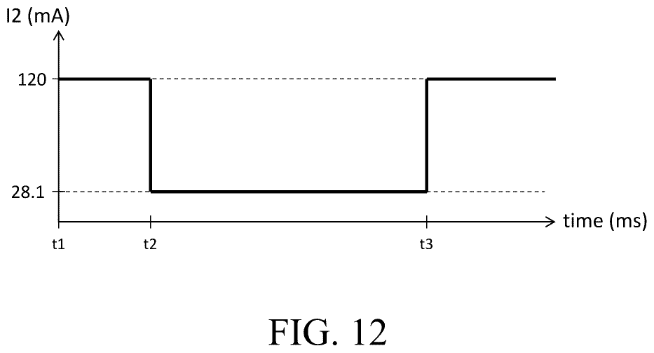

Please refer to FIG. 1 to FIG. 4, FIG. 6, FIG. 7, FIG. 9, FIG. 11, and FIG. 12, the current 12 shown in FIG. 11 and FIG. 12 is the current 12 of the wireless communication device 10. In some embodiments, the larger the current 12 of the wireless communication device 10, the higher the power consumption of the wireless communication device 10. On the other hand, the smaller the current 12 of the wireless communication device 10, the lower the power consumption of the wireless communication device 10.

Take FIG. 11 for example. In the embodiment shown in FIG. 11, the duty cycle Dtb of the transmission period Ttb is 80% (as shown in FIG. 4). Between the time point t1 and the time point t2, the wireless communication device 10 is communicating with the station 20 (as shown in FIG. 7 and FIG. 9), and the power consumption of the wireless communication device 10 reaches the maximum (the current 12 of the wireless communication device 10 is, for example, 120 mA, but is not limited thereto). Between the time point t2 and the time point t3, the wireless communication device 10 is not communicating with any station 20, and the wireless communication device 10 controls the wireless communication circuit 100 and the system chip 110 to sleep to reduce the power consumption of the wireless communication device 10. Since the time that the beacon communication circuit 130 enters into the working state during the transmission period Ttb (i.e., the first period T1) is longer, the reduction of the power consumption of the wireless communication device 10 is smaller. In some embodiments, the current 12 of the wireless communication device 10 drops from 120 mA to 59.1 mA. After the time point t3, the wireless communication device 10 listens to the authentication request packet Rf2 sent from the station 20 or the data packet (not shown) sent from the station 20. When the wireless communication device 10 listens to the authentication request packet Rf2 or the data packet, the wireless communication device 10 wakes up the wireless communication circuit 100 and the system chip 110 to communicate with the station 20. Therefore, the power consumption of the wireless communication device 10 returns to the maximum again.

Further take FIG. 12 for example. In the embodiment shown in FIG. 12, the duty cycle Dtb of the transmission period Ttb is 30% (as shown in FIG. 6). Between the time point t1 and the time point t2, the wireless communication device 10 is communicating with the station 20 (as shown in FIG. 7 and FIG. 9), and the power consumption of the wireless communication device 10 reaches the maximum (the current 12 of the wireless communication device 10 is, for example, 120 mA, but is not limited thereto). Between the time point t2 and the time point t3, the wireless communication device 10 is not communicating with any station 20, and the wireless communication device 10 controls the wireless communication circuit 100 and the system chip 110 to sleep to reduce the power consumption of the wireless communication device 10. Since the time that the beacon communication circuit 130 enters into the sleeping state during the transmission period Ttb (i.e., the second period T2) is longer, the reduction of the power consumption of the wireless communication device 10 is larger. In some embodiments, the current 12 of the wireless communication device 10 drops from 120 mA to 28.1 mA. After the time point t3, the wireless communication device 10 listens to the authentication request packet Rf2 sent from the station 20 or the data packet (not shown) sent from the station 20. When the wireless communication device 10 listens to the authentication request packet Rf2 or the data packet, the wireless communication device 10 wakes up the wireless communication circuit 100 and the system chip 110 to communicate with the station 20. Therefore, the power consumption of the wireless communication device 10 returns to the maximum again.

In conclusion, according to one or some embodiments, the wireless communication device controls the wireless communication circuit and the system chip to sleep so as to reduce the power consumption during standby. Moreover, the wireless communication device further reduces the power consumption during standby by adjusting the duty cycle of the transmission period for the beacon communication circuit. Besides, since the beacon communication circuit alternately enters into the working state and the sleeping state multiple times in every transmission period, the communication performance of the wireless communication device can be maintained while reducing the power consumption of the wireless communication device.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A wireless communication device comprising:
a wireless communication circuit;
a system chip electrically connected to the wireless communication circuit, wherein the system chip is configured to successively make the wireless communication circuit and the system chip sleep in response to a power saving demand and configured to receive a wake-up signal to successively awake the system chip and the wireless communication circuit;
a wake-up controller electrically connected to the system chip, wherein the wake-up controller is configured to send the wake-up signal to the system chip; and
a beacon communication circuit electrically connected to the wake-up controller, wherein the beacon communication circuit is configured to send a beacon packet periodically according to a transmission period, and the beacon communication circuit is configured to alternately enter into a working state and a sleeping state multiple times in every transmission period, wherein the beacon communication circuit listens to at least one connection request signal when the beacon communication circuit enters into the working state.

2. The wireless communication device according to claim 1, wherein the system chip is further configured to disable an interrupt function of the system chip.

3. The wireless communication device according to claim 1, wherein the at least one connection request signal includes an authentication request packet sent from a station or a data packet sent from the station, and the wake-up controller sends the wake-up signal to the system chip when the beacon communication circuit listens to the authentication request packet or the data packet.

4. The wireless communication device according to claim 3, wherein the at least one connection request signal further includes a probe request packet sent from the station, and the beacon communication circuit sends a probe response packet to the station when the beacon communication circuit listens to the probe request packet.

5. The wireless communication device according to claim 1, wherein a duty cycle of the transmission period is between 30% and 80%.

6. The wireless communication device according to claim 1, wherein the beacon communication circuit alternately enters into the working state and the sleeping state 5 times in every transmission period.

7. A power saving method adapted to a wireless communication device, wherein the wireless communication device includes a wireless communication circuit, a system chip, a beacon communication circuit, and a wake-up controller, and wherein the power saving method comprises:
making the wireless communication circuit sleep in response to a power saving demand;
disabling an interrupt function of the system chip and making the system chip sleep; and
sending a beacon packet periodically according to a transmission period and alternately entering into a working state and a sleeping state multiple times in every transmission period when the system chip and the wireless communication circuit sleep.

8. The power saving method according to claim 7, further comprising:
receiving an authentication request packet sent from a station or a data packet sent from the station;
triggering the wake-up controller to send a wake-up signal to the system chip to wake up the system chip;
waking up the wireless communication circuit; and
controlling the wireless communication circuit to communicate with the station.

9. The power saving method according to claim 7, further comprising:
receiving a probe request packet sent from a station;
sending a probe response packet to the station;
receiving an authentication request packet sent from the station or a data packet sent from the station;
triggering the wake-up controller to send a wake-up signal to the system chip to wake up the system chip;
waking up the wireless communication circuit; and
controlling the wireless communication circuit to communicate with the station.

10. The power saving method according to claim 7, wherein a duty cycle of the transmission period is between 30% and 80%.
